(19) United States
(12) Patent Application Publication
(10) Pub. No.: US 2017/0060206 A1
(43) Pub. Date: Mar. 2, 2017

(54) SYSTEM AND METHOD FOR GENERATING A SUSTAINED THERMAL POWER ENVELOPE FOR A PORTABLE COMPUTING DEVICE

(71) Applicant: QUALCOMM INCORPORATED, San Diego, CA (US)

(72) Inventors: Kwangyoon Lee, San Diego, CA (US); Adam Cunningham, San Diego, CA (US); Melanie Dolores Oclima, San Diego, CA (US)

(21) Appl. No.: 14/959,997

(22) Filed: Dec. 4, 2015

Related U.S. Application Data
(60) Provisional application No. 62/213,017, filed on Sep. 1, 2015.

(51) Int. Cl. G06F 1/26

(52) U.S. Cl. CPC G06F 1/26

(57) ABSTRACT

A Sustained Thermal Power Envelope may be generated by monitoring a circuitry-level temperature in a portable computing device, monitoring a skin temperature of the portable computing device, monitoring an ambient temperature, operating the portable computing device during multiple time periods during which a circuitry-level temperature remains substantially constant, determining an average skin temperature during each time period, adjusting the skin temperature data by subtracting the ambient temperature, and generating data pairs of adjusted skin temperature and the power consumed during the time period.

### CROSS-REFERENCE TO RELATED APPLICATION

The benefit of the filing date of U.S. Provisional Patent Application No. 62/213,017, filed Sep. 1, 2015, entitled “SYSTEM AND METHOD FOR GENERATING A SUSTAINED THERMAL POWER ENVELOPE FOR A PORTABLE COMPUTING DEVICE,” is hereby claimed, and the specification thereof incorporated herein in its entirety by this reference.

### DESCRIPTION OF THE RELATED ART

Portable computing devices (“PCD”s) are becoming necessities for people on personal and professional levels. These devices may include cellular telephones, portable digital assistants, portable game consoles, palmtop computers, and other portable electronic elements.

In operation, the electronic circuitry within a PCD generates heat or thermal energy, which at excessive levels may be detrimental to the circuitry. The amount of thermal energy that is generated may vary depending upon the operating conditions. For example, in an instance in which a PCD is wirelessly transmitting data for a sustained time period at a high power level, the power amplifier that feeds the antenna may generate a potentially detrimental amount of thermal energy. Integrated circuit chips, such as processors, may also generate substantial thermal energy when operating at high workload levels.

Some PCDs include thermal sensors positioned near the electronic circuitry that the PCD processor may monitor to determine if the PCD or portion thereof has reached a threshold or critical temperature. When a reading of the thermal sensor indicates that a PCD has reached such a threshold temperature, the processor may initiate an action intended to reduce thermal energy production or otherwise mitigate the effects of the thermal energy. For example, the processor may temporarily reduce power to some of the electronics generating the thermal energy, in order to allow the PCD to dissipate the excess thermal energy. Using temperature feedback to adjust how a PCD operates is sometimes referred to as “thermal management.”

A Sustained Thermal Power Envelope (“S-TPE”) is a metric used to evaluate the effectiveness of a PCD's thermal mechanical design, i.e., how much power the PCD can dissipate while operating for a sustained time at a given skin temperature. An S-TPE may be expressed as a collection of data points comprising skin temperature and power. Persons involved in designing a PCD may compare the S-TPE of a proposed PCD design against industry standards or other benchmarks or against the S-TPE of an alternative PCD design. To perform such tasks, it is necessary to generate an S-TPE for a PCD.

### SUMMARY OF THE DISCLOSURE

Systems, methods, and computer program products are disclosed for generating a Sustained Thermal Power Envelope (“S-TPE”) for a portable computing device (“PCD”). An exemplary method for generating an S-TPE comprises: monitoring a circuitry-level temperature of the PCD; monitoring a skin temperature of a housing of the PCD; monitoring an ambient temperature in an environment external to the housing of the PCD; operating the PCD during each of a plurality of time periods, wherein during each time period the PCD draws a unique amount of power defining a power value, and during each time period the circuitry-level temperature remains at a substantially constant unique temperature; determining an average skin temperature during each time period; determining an adjusted skin temperature during each time period by subtracting the ambient temperature during the time period from the average skin temperature during the time period; and generating a plurality of pairs of data points, wherein each data point corresponds to one of the plurality of time periods, and each data point comprises an adjusted skin temperature value and a power value.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a system for generating an S-TPE for a PCD, in accordance with an exemplary embodiment.

FIG. 2 illustrates an S-TPE in the exemplary form of a plurality of skin temperature and power data point pairs.

FIG. 3 is a flow diagram illustrating a method for generating an S-TPE for a PCD, in accordance with an exemplary embodiment

FIG. 4 is a flow diagram illustrating the method of FIG. 3 in further detail.

FIG. 5 is a block diagram of a portable computing device configured for generating an S-TPE for a PCD, in accordance with an exemplary embodiment.

FIG. 6 is a conceptual hardware diagram illustrating a PCD processor having large-core and small-core clusters, in accordance with an exemplary embodiment.

FIG. 7 is a flow diagram illustrating a first portion of the flow diagram of FIG. 4 in further detail.

FIG. 8 is a flow diagram illustrating a second portion of the flow diagram of FIG. 4 in further detail.

FIG. 9 is a flow diagram illustrating a third portion of the flow diagram of FIG. 4 in further detail.

FIG. 10 is a flow diagram illustrating a fourth portion of the flow diagram of FIG. 4 in further detail.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “portable computing device” (“PCD”) is used to describe any device operating on a limited-capacity power supply, such as a battery, and lacking a system for removing excess thermal energy (i.e., for cooling, such as a fan, etc.). Although battery operated PCDs have been in use for decades, technological advances in rechargeable batteries coupled with the advent of third generation (“3G”) and fourth generation (“4G”) wireless technology have enabled numerous PCDs with multi-faceted capabilities. Therefore, the term “PCD” may encompass a cellular telephone (e.g., a smartphone), a satellite telephone, a pager, a personal digital assistant (“PDA”), a navigation device, a smartbook or reader, a media player, a laptop or hand-held computer with a wireless connection, or a combination of the aforementioned devices, among others.

The terms “central processing unit” (“CPU”), “digital signal processor” (“DSP”), and “graphics processing unit” (“GPU”) are non-limiting examples of processors that may reside in a PCD. These terms are used interchangeably except where otherwise indicated.

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, encompasses any measurement that may be indicative of the relative warmth, or absence of heat, of a thermal energy-generating device or component.

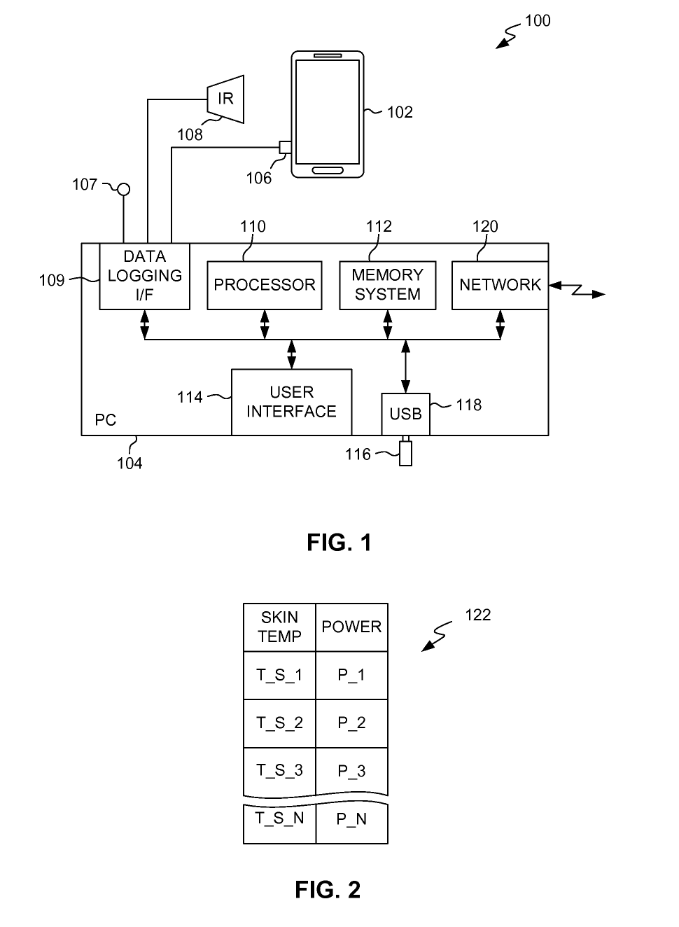

As illustrated in FIG. 1, in an illustrative or exemplary embodiment, a system 100 for generating a Sustained Thermal Power Envelope (“S-TPE”) includes a PCD 102, such as a mobile telephone, and also includes a computer 104, such as a desktop or laptop computer. System 100 further includes a skin temperature sensor 106, such as a thermocouple, thermistor, or similar sensor of conducted or radiated heat, attached to or otherwise thermally associated with the housing of PCD 102. In addition or alternatively to skin temperature sensor 106, system 100 may include an infrared camera 108 or similar sensor of radiated heat directed upon or otherwise thermally associated with the housing of PCD 102. System 100 further includes an ambient temperature sensor 107, such as a thermocouple or thermistor. Ambient temperature sensor 107 is located in the immediate environment of PCD 102, such as a room in which PCD 102 is located. Ambient temperature sensor 107 may be located at a distance from PCD 102 sufficient to avoid being significantly affected by thermal energy radiated from PCD 102.

As described below, computer 104 is configured to monitor skin temperature sensor 106 and/or 108 and ambient temperature sensor 107. Computer 104 may include a data logging interface 109 to aid in obtaining and storing temperature measurements from sensors 106-108. In addition to being configured with software to operate in the manner described below, computer 104 may include any hardware and software elements of the types commonly included in desktop or laptop computers, such as a processor 110, a memory system 112 (e.g., DRAM, ROM, magnetic or optical disk, flash memory, etc., or a combination thereof), and a user interface 114 (e.g., keyboard, mouse, display screen, etc.). One or more of the method steps described below may be implemented by processor-executable code or instructions stored in memory system 112. A removable data storage medium 116 may be connected to a Universal Serial Bus (“USB”) port 118 of computer 104. A network interface 120 may also be included. As described below, a user may control system 100 in part via user interface 114. Computer 104 may output the generated S-TPE in any manner, such as storing it in the form of a data file on removable data storage medium 116, transmitting such a data file via network interface 120, or displaying the S-TPE on a display screen of user interface 114. As illustrated in FIG. 2, a generated S-TPE 122 may comprise N data points, each consisting of a skin temperature value (“T_S_1” through “T_S_N”) and a corresponding power value (“P_1” through “P_N”).

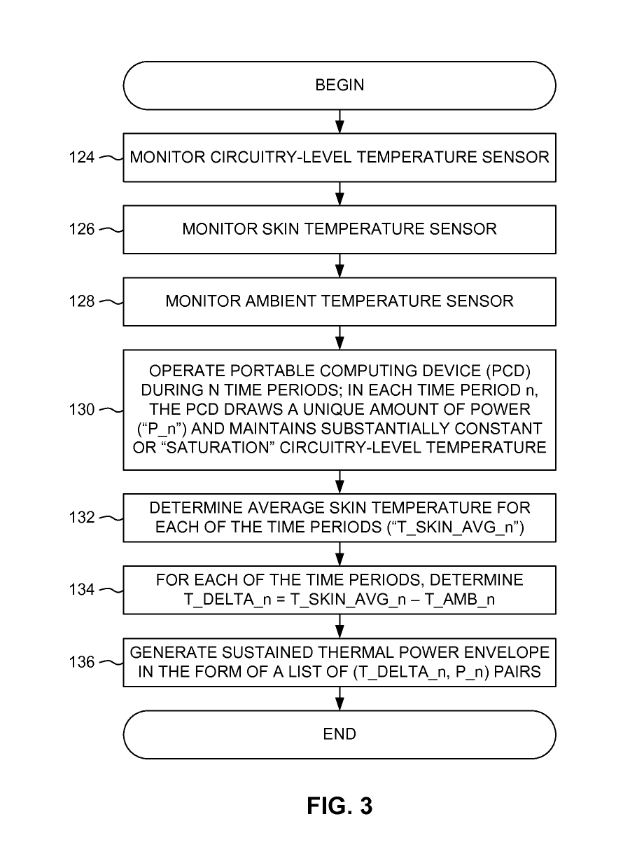

In the exemplary embodiment, a method for generating an S-TPE may be effected through a combination of the operation of PCD 102 and the operation of computer 104 (FIG. 1), each under control of software. Such software may be represented by the methods described below with regard to FIGS. 3-10. In view of the following descriptions, one of ordinary skill in the art readily will be capable of generating or otherwise providing such software, and programming or otherwise configuring PCD 102 and computer 104 accordingly to embody such logic. As used in this specification, the term “software” encompasses processor-executable code or instructions in any form, including forms commonly referred to as software, firmware, programmable logic, etc. It should be noted that a combination of a non-transitory computer-readable storage medium and the computer-executable code or instructions stored therein for execution by a processor defines a “computer program product” as that term is understood in the patent lexicon. Furthermore, PCD 102 or computer 104, or one or more processors thereof, as programmed or configured with such instructions, may serve as a “means” for performing one or more of the method steps described herein.

Although certain acts or steps in the methods described below naturally precede others for the exemplary embodiments to operate as described, the invention is not limited to the order of those acts or steps if such order or sequence does not alter the functionality of the invention. That is, it is recognized that some acts or steps may be performed before, after, or in parallel (i.e., substantially simultaneously) with other acts or steps without departing from the scope and spirit of the invention. In some instances, certain acts or steps may be omitted or not performed, without departing from the scope and spirit of the invention. Further, words such as “thereafter,” “then,” “next,” etc., are not intended to limit the order of the acts or steps. Rather, such words are used to aid in guiding the reader through the descriptions of the exemplary methods.

An exemplary method for generating an S-TPE is illustrated by a high-level flow diagram in FIG. 3. As indicated by block 124, at least one circuitry-level temperature sensor in PCD 102 is monitored. Similarly, as indicated by block 126, at least one skin temperature sensor 106 or 108 (FIG. 1) is monitored. Likewise, as indicated by block 128, at least one ambient temperature sensor 107 (FIG. 1) is monitored. As indicated by block 130, PCD 102 is operated during each of a number (“N”) of time periods. During each time period (which may be referred to as an “nth” time period, where the variable “n” indicates or indexes a time period between the first time period and the Nth time period), PCD 102 draws a unique amount of battery power (“P_n”). The word “unique” in this context refers to an amount of power that is different from the amount drawn during any of the other time periods. For example, power drawn during different time periods may include 1.0 watts (“W”), 1.5 W, 2.0 W, 2.5 W, etc., and may be distributed evenly over a range, such as, for example, between 1.0 W and 4.0 W. Also, during each time period, PCD 102 maintains or remains at a substantially constant or “saturation” circuitry-level temperature as measured by one or more circuitry-level temperature sensors.

As indicated by block 132, the average skin temperature (“T_SKIN_AVG_n”) for each of the time periods is determined. As indicated by block 134, each such average skin temperature value is adjusted to account for the ambient temperature by subtracting the ambient temperature during the time period: T_DELTA_n=T_SKIN_AVG_n−T_AMB_n. As indicated by block 136, an S-TPE may be generated in the form of a list of T_DELTA_n and P_n pairs.

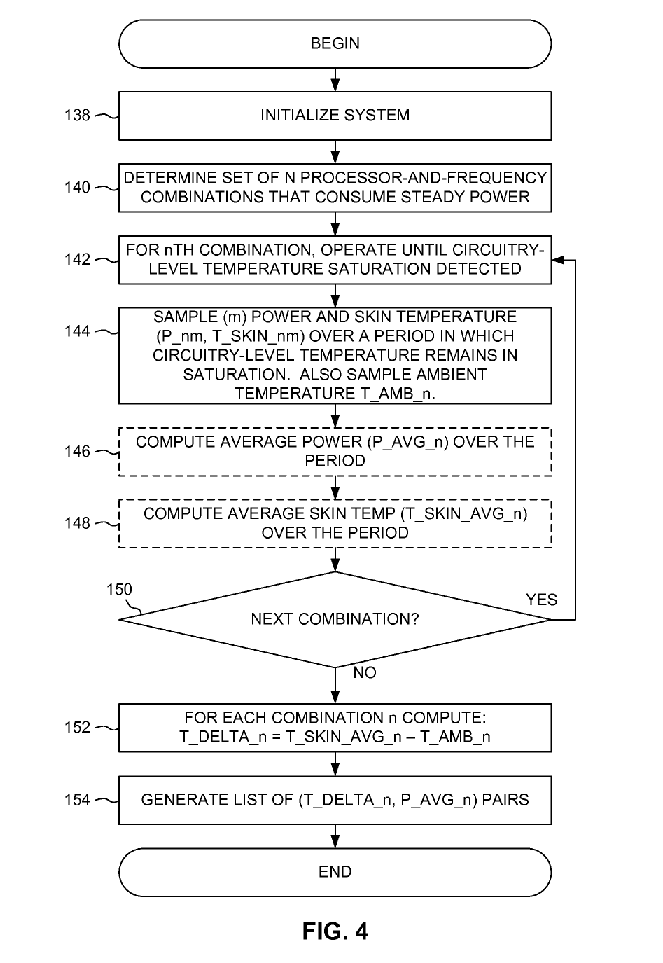

An exemplary method for generating an S-TPE is also illustrated by another flow diagram in FIG. 4 that includes additional detail. An operator, i.e., a user, of system 100 (FIG. 1) may initiate the method by interacting with computer 104 via user interface 114 and by similarly interacting with PCD 102. As indicated by block 138, aspects of system 100 may be initialized before the method proceeds further. For example, a circuitry-level temperature sensor may be read to confirm that the initial temperature reading is below a threshold before proceeding. Other initializations of the types that are commonly performed in data-logging and instrumentation systems may also be performed.

As indicated by block 140, a set of N processor-and-frequency combinations is determined. An exemplary manner in which the set of processor-and-frequency combinations may be determined is described below. However, for purposes of understanding the method illustrated by the flow diagram in FIG. 4, it may be appreciated that each processor-and-frequency combination corresponds to one of the N time periods, and that each processor-and-frequency combination comprises one or more processors of PCD 102 and, correspondingly, a frequency at which each processor in that processor-and-frequency combination may be operated. Although the power drawn by a processor-and-frequency combination may fluctuate about a nominal power level as the processor proceeds through the various computations or other data manipulations that constitute its workload, P_n represents the nominal power level. It may be appreciated that the amount of power drawn during operation of a processor-and-frequency combination is dependent upon several factors, including the number of processors in the combination, the size of each processor in the combination, the frequency at which each processor in the combination runs (i.e., is operated), and the extent to which the resources of each processor in the combination are utilized. With regard to utilization of processor resources, it is contemplated that each processor in a combination runs or is operated under control of software that extensively utilizes the processor resources, thereby promoting maximum power usage. Such software may be referred to as processor-intensive. Such software (e.g., an application program) may be downloaded from computer 104 or other source to PCD 102 in a conventional manner. As well understood by one of ordinary skill in the art, some commercially available PCD operating systems, such as the Android operating system developed by Google, Inc., include features through which an application program may select one or more processors and select a clock signal frequency at which each selected processor is to be run.

Blocks 142, 144, 146, 148 and 150 relate to an iterative or looping portion of the method that loops through the set of N processor-and-frequency combinations. As indicated by block 142, for an nth processor-and-frequency combination, each processor in the combination is operated at its corresponding frequency until a “saturation” condition of the circuitry-level temperature is detected. Detection of the saturation condition is described in further detail below.

As indicated by block 144, once an nth processor-and-frequency combination is operating in the saturation condition, a number (“m”) of successive samples of the power (“P_nm”) and skin temperature (“T_SKIN_nm”) may be obtained or logged. PCD 102 may sample power at evenly distributed intervals throughout the time period, such as, for example, once per second over a 2-minute time period. The sampled power values are stored in PCD memory. Computer 104 may sample or log the skin temperature as well as the ambient temperature T_AMB_n. Computer 104 samples the skin temperature and ambient temperature at least during the time periods during which PCD 102 samples the power. Computer 104 may store the skin temperature and ambient temperature samples in memory system 112 (FIG. 1).

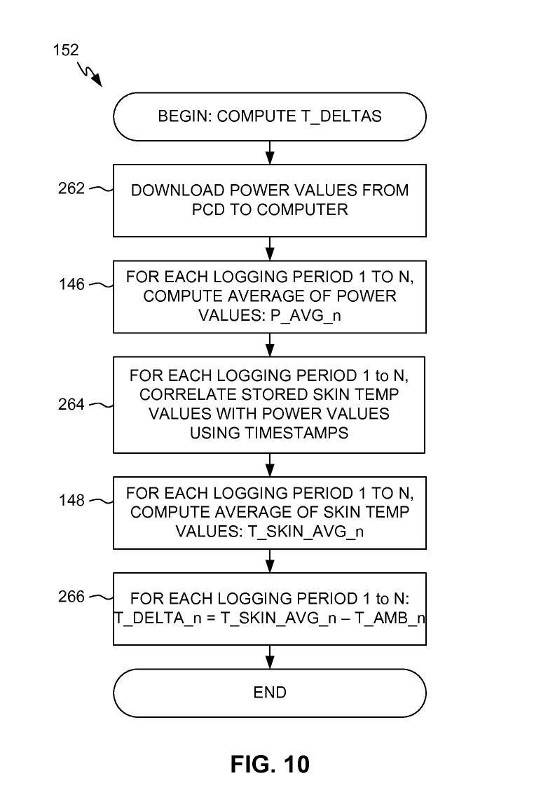

As indicated by block 146, an average power value (“P_AVG_n”) over each time period is determined. Similarly, as indicated by block 148, an average skin temperature value (“T_SKIN_AVG_n”) over each time period is determined. Note that although blocks 146 and 148 are shown within the logical flow loop in FIG. 4 for clarity of description, in the exemplary embodiment these averages may be computed after the loop is exited. Average power may be computed by PCD 102 or, alternatively, by computer 104 by downloading the sampled power values from PCD memory to the computer's memory system 112. As described in further detail below with regard to FIG. 10, computer 104 may download timestamps associated with the sampled power values from PCD 102 and compare or correlate those timestamps with timestamps associated with the skin temperature samples to correlate the skin temperature and ambient temperature samples with the power samples.

As indicated by block 150, the method loops back to block 142 and is repeated with the next processor-and-frequency combination, until all processor-and-frequency combinations in the set have been operated and the data logged as described above. When all processor-and-frequency combinations in the set have been operated and the data logged as described above, the loop is exited.

Blocks 152 and 154 may similar to above-described blocks 134 and 136 (FIG. 3), respectively. Thus, for each time period (and accordingly, each processor-and-frequency combination), the ambient temperature is subtracted from the average skin temperature value: T_DELTA_n=T_SKIN_AVG_n−T_AMB_n. Then, the S-TPE may be generated in the form of a list of the N pairs of T_DELTA_n and P_n.

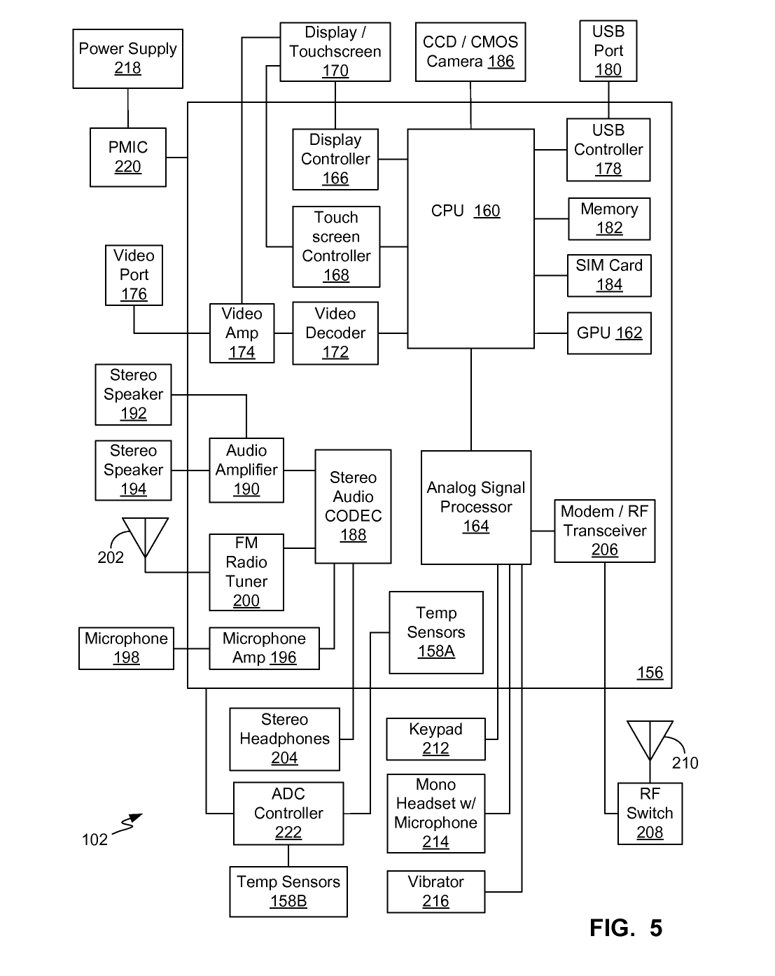

As illustrated in FIG. 5, in an illustrative or exemplary embodiment, PCD 102 includes an on-chip system 156, i.e., a system embodied in an integrated circuit chip. On-chip system 156 may monitor one or more internal circuitry-level temperature sensors 158A (which may be spatially distributed about the chip) or one or more external circuitry-level temperature sensors 158B (collectively referred to as circuitry-level temperature sensors 158). Internal circuitry-level temperature sensors 158A may comprise, for example, one or more proportional to absolute temperature (“PTAT”) temperature sensors that are based on vertical PNP structure of the type known to be usable with CMOS very large-scale integration (“VLSI”) circuits. External circuitry-level temperature sensors 158B may comprise, for example, one or more thermistors in thermal contact with circuitry within PCD 102 but not integrated with on-chip system 156. Although in the exemplary embodiment computer 104 uses skin temperature sensor 106 or infrared camera 108 (FIG. 1) to sense the skin temperature of PCD 102, in other embodiments PCD 102 may sense its own skin temperature using external circuitry-level temperature sensors 158B.

In PCD 102, the processors of on-chip system 156 include a central processing unit (“CPU”) 160 and a graphics processing unit (“GPU”) 162. PCD 102 also includes an analog signal processor 164.

A display controller 166 and a touchscreen controller 168 are coupled to CPU 160. A touchscreen display 170 external to on-chip system 156 is coupled to display controller 166 and touchscreen controller 170. PCD 102 may further include a video decoder 172. Video decoder 172 is coupled to CPU 160. A video amplifier 174 is coupled to video decoder 172 and touchscreen display 170. A video port 176 is coupled to video amplifier 174. A universal serial bus (“USB”) controller 178 is also coupled to CPU 160, and a USB port 180 is coupled to USB controller 178. A memory 182 and a subscriber identity module (“SIM”) card 184 may also be coupled to CPU 160. In addition, a digital camera 186 may be coupled to CPU 160.

A stereo audio CODEC 188 may be coupled to analog signal processor 164. Further, an audio amplifier 190 may be coupled to stereo audio CODEC 188. First and second stereo speakers 192 and 194, respectively, may be coupled to audio amplifier 190. In addition, a microphone amplifier 196 may be also coupled to stereo audio CODEC 188, and a microphone 198 may be coupled to microphone amplifier 196. A frequency modulation (“FM”) radio tuner 200 may be coupled to stereo audio CODEC 188. An FM antenna 202 is coupled to the FM radio tuner 200. Further, stereo headphones 204 may be coupled to stereo audio CODEC 188.

A modem or radio frequency (“RF”) transceiver 206 may be coupled to analog signal processor 164. An RF switch 208 may be coupled to RF transceiver 206 and an antenna 210. In addition, a keypad 212, a mono headset with a microphone 214, and a vibrator device 216 may be coupled to analog signal processor 164.

A power supply 218, such as a battery, is coupled to on-chip system 156 via a power management integrated circuit (“PMIC”) 220. In a particular aspect, power supply 218 includes a rechargeable battery or a DC power supply that is derived from an AC-to-DC transformer connected to an AC power source. On-chip system 156 may obtain the above-referenced battery power samples from PMIC 220.

In response to thermal energy, circuitry-level temperature sensors 158 may produce a voltage drop. An analog-to-digital converter (“ADC”) controller 222 converts the voltage drops to digital signals and provides the digital signals to on-chip system 156. However, in other embodiments other types of circuitry-level temperature sensors 158 alternatively may be employed.

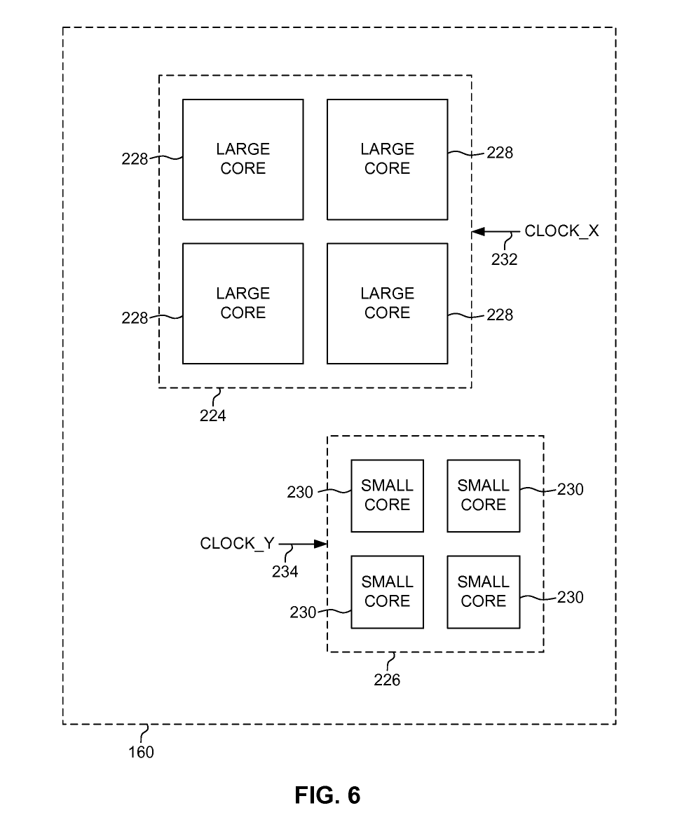

As illustrated in FIG. 6, CPU 160 or other processor may comprise one or more large-core clusters 224 and one or more small-core clusters 226. Each large-core cluster 224 comprises two or more large cores 228. Each small-core cluster 226 comprises two or more smaller cores 230. Generally, for a given clock frequency and given processor workload, a larger core generates more thermal energy than a smaller core. A large-core cluster 224 receives a clock signal 232 (“CLOCK_X”), which may be dynamically selected under software control to be of any of a number of discrete frequencies. Likewise, a small-core cluster 226 receives a clock signal 234 (“CLOCK_Y”), which may be dynamically selected under software control to be of any of a number of discrete frequencies. The set of selectable frequencies to which clock signal 232 may be set may differ from the set of selectable frequencies to which clock signal 234 may be set.

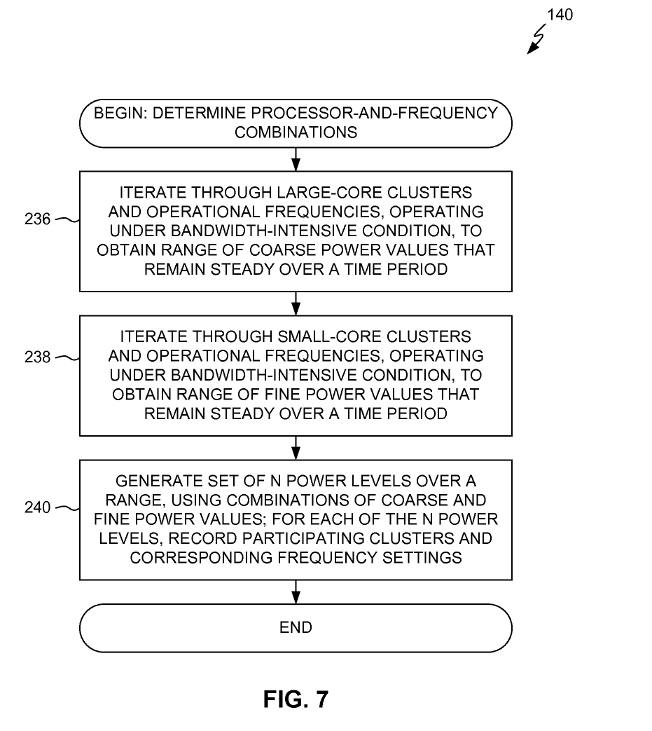

Above-described block 140 (FIG. 4) is illustrated in further detail in FIG. 7. As indicated by blocks 236 and 238, respectively, the large-core clusters 224 and small-core clusters 226 are iterated through, operating each with a range of different frequencies and sensing the power drawn by each such processor-and-frequency combination. As large-core clusters 224 can be expected to generate more thermal energy than small-core clusters 226, the power readings resulting from operating the large-core clusters 224 can be used as coarse or base values, to which the power readings resulting from operating the small-core clusters 226 can be added to more finely achieve a desired power value. For example, it may be determined that operating a large-core cluster 224 at a frequency f1 draws 1 W, and that operating a small-core cluster 226 at another frequency f2 draws 0.5 W. In such an exemplary instance, a first unique power value of 1 W could be developed by a processor-and-frequency combination of large-core cluster 224 operating at frequency f1, and a second unique power value of 1.5 W could be developed by a processor-and-frequency combination of large-core cluster 224 operating at frequency f1 in combination with small-core cluster 226 simultaneously operating at frequency f2. Continuing with this example, it may be determined that operating large-core cluster 224 at still another frequency f3 draws 2 W. Thus, a third unique power value of 2 W could be developed by a processor-and-frequency combination of large-core cluster 224 operating at frequency f3, and a fourth unique power value of 2.5 W could be developed by a processor-and-frequency combination of large-core cluster 224 operating at frequency f3 in combination with small-core cluster 226 simultaneously operating at frequency f2. A range of N unique power values that define the power portion of the S-TPE may be compiled in this manner. For each unique power value, information identifying the participating processors and the corresponding operating frequencies is recorded for use in a further step of the method.

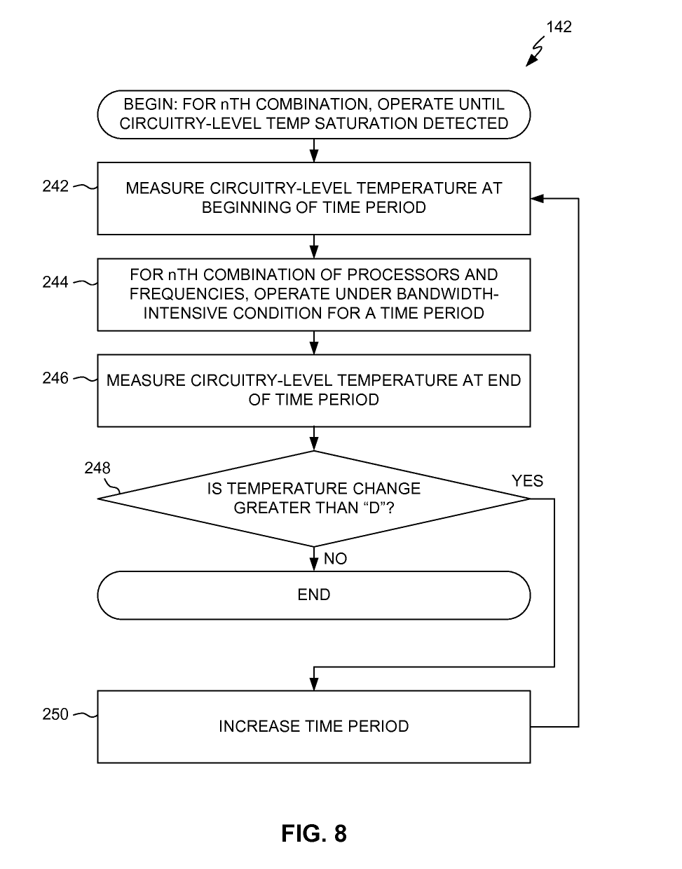

Above-described block 142 (FIG. 4) is illustrated in further detail in FIG. 8. As indicated by block 242, a first reading or measurement is obtained from a circuitry-level temperature sensor 158. As indicated by block 244, an nth processor-and-frequency combination is operated for a saturation time period. Note that this is not the same time period as described above with regard to blocks 130 and 134 but rather is a saturation time period, during which the measured circuitry-level temperature reaches a saturation temperature. The term “saturation” refers to a temperature that does not fluctuate more than a threshold amount over the saturation time period. Thus, as indicated by block 246, a second reading or measurement is obtained from the circuitry-level temperature sensor 158 at the end of the saturation time period. Then, as indicated by block 248, it is determined from the difference between the first and second readings whether the circuitry-level temperature changed by more than a threshold amount (“D”) over the saturation time period. A threshold amount may be, for example, plus or minus one degree Celsius. If it is determined (block 248) that the circuitry-level temperature did not change by more than the threshold amount, then the circuitry-level temperature is deemed to have reached a saturation condition. However, if it is determined (block 248) that the circuitry-level temperature changed by more than the threshold amount, then the saturation time period is increased, as indicated by block 250. For example, if the circuitry-level temperature has not reached a saturation condition after a first saturation time period of one minute, then the saturation time period may be increased to five minutes and the above-described steps repeated. It may then be determined (blocks 242-248) whether the circuitry-level temperature has reached a saturation condition after an additional five-minute saturation time period. If it is determined (block 248) that the circuitry-level temperature did not change by more than the threshold amount after the additional five minutes, then the circuitry-level temperature is deemed to have reached a saturation condition. However, if it is determined (block 248) that the circuitry-level temperature changed by more than the threshold amount, then the saturation time period is again increased (block 250). For example, if the circuitry-level temperature has not reached a saturation condition after a first saturation time period of one minute followed by a second saturation time period of five minutes, then the saturation time period may be increased to ten minutes and the above-described steps repeated. It may then be determined (blocks 242-248) whether the circuitry-level temperature has reached a saturation condition after the additional ten-minute saturation time period, etc.

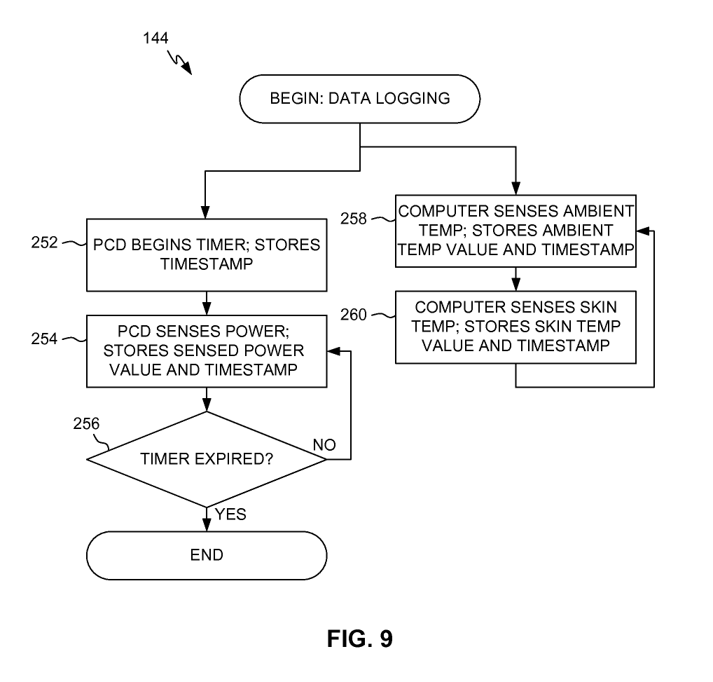

Above-described block 144 (FIG. 4) is illustrated in further detail in FIG. 9. As described above with regard to FIG. 4, block 144 relates to a data logging loop. This data logging phase is begun once it is determined that the circuitry-level temperature has reached a saturation condition, as described above. In PCD 102, power measurements are logged. As indicated by block 252, PCD 102 begins a timer and stores a timestamp indicating the beginning of the time period. As indicated by block 254, PCD 102 senses the battery power (e.g., by reading PMIC 220, shown in FIG. 5) and stores the measured power value. PCD 102 may also store a timestamp indicating the time at which the battery power was sensed. Alternatively, such a timestamp may be omitted in an embodiment in which a timestamp indicating the beginning of the time period or a timestamp indicating the beginning of data logging is used instead. As indicated by block 256, if the time period has not yet elapsed (e.g., a timer set to correspond to the time period has not yet expired), then the next power sample is obtained (block 254). Although in the exemplary embodiment the time period may be, for example, two minutes, the time period may be of any other length. One of ordinary skill in the art readily will be capable of selecting a time period and other data logging parameters.

In the exemplary embodiment, while PCD 102 is logging power measurements, computer 104 may be logging skin temperature and ambient temperature. As indicated by block 258, computer 104 reads ambient temperature sensor 107 (FIG. 1) and stores the ambient temperature reading along with a timestamp indicating the time at which the reading was taken. Similarly, as indicated by block 258, computer 104 reads skin temperature sensor 106 or infrared camera 108 (FIG. 1) and stores the skin temperature reading along with a timestamp indicating the time at which the reading was taken. Reading ambient temperature (block 258) and reading skin temperature (block 260) are then repeated. Although not shown for purposes of clarity, reading ambient temperature and reading skin temperature may repeat until the process is stopped, for example, either manually by an operator or by the occurrence of an event, such as expiration of a timer. Although in the exemplary embodiment the process of computer 104 reading the ambient temperature and skin temperature is asynchronous from the process of PCD 102 reading the power value, in other embodiments it may be possible to synchronize these processes. Also, although in the exemplary embodiment computer 104 obtains the same number of ambient temperature readings (block 258) as skin temperature readings (block 260), in other embodiments the ambient temperature may be read less frequently than the skin temperature, since the ambient temperature generally does not change substantially during each data logging time period.

A method similar to the method or steps described above with regard to blocks 152 and 154 (FIG. 4) is illustrated in further detail in FIG. 10. As indicated by block 262, computer 104 may download the sampled power values from PCD 102. Computer 104 may also download the timestamps associated with those sampled power values. For example, computer 104 may download timestamps indicating the beginning of each time period in which the power values were sampled. Blocks 146 and 148, which are described above with regard to FIG. 4, are also shown in FIG. 10 because in the exemplary embodiment the steps indicated by blocks 146 and 148 are performed after data logging is completed. In accordance with block 146, P_AVG_n, which is the average of the power values for each logging time period is determined. As indicated by block 264, for each power logging period the associated timestamp is compared with the timestamps associated with the skin temperature and ambient temperature samples to correlate the skin temperature and ambient temperature samples with the power samples. Thus, the average skin temperature T_SKIN_AVG_n is determined (in accordance with block 148) from skin temperature values sampled during the same time period as the time period in which the power values (averaged in accordance with block 146) were sampled. Then, as indicated by block 266, the above-described adjusted skin temperature values T_DELTA_n are determined by subtracting the value of ambient temperature sampled during the same time period as the time period in which the power values (averaged in accordance with block 146) were sampled. The correlating step thus enables the adjusted average skin temperature values T_DELTA_n to be paired with corresponding average power values to produce the S-TPE, as described above with regard to block 154 (FIG. 4).

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for generating a Sustained Thermal Power Envelope in a portable computing device, the method comprising:
monitoring a circuitry-level temperature of the portable computing device;
monitoring a skin temperature of a housing of the portable computing device;
monitoring an ambient temperature in an environment external to the housing of the portable computing device;
operating the portable computing device during each of a plurality of time periods, during each time period the portable computing device drawing a unique amount of power defining a power value, during each time period the portable computing device maintaining the circuitry-level temperature at a substantially constant unique temperature;
determining an average skin temperature during each time period;
determining an adjusted skin temperature during each time period by subtracting the ambient temperature during the time period from the average skin temperature during the time period; and
generating a plurality of pairs of data points, each data point corresponding to one of the plurality of time periods, each data point comprising an adjusted skin temperature value and a power value.

2. The method of claim 1, further comprising determining a plurality of combinations, each combination corresponding to one of the time periods, each combination comprising one or more processors and corresponding operating frequencies, each combination drawing the unique amount of power.

3. The method of claim 2, wherein the processors include large-core clusters and small-core clusters, and determining a plurality of combinations comprises including a small-core cluster and a large-core cluster in a combination.

4. The method of claim 1, wherein operating the portable computing device during each of a plurality of time periods comprises detecting when the circuitry-level temperature reaches the substantially constant unique temperature.

5. The method of claim 4, wherein detecting when the circuitry-level temperature reaches the substantially constant unique temperature comprises:
determining whether the circuitry-level temperature remains substantially constant during a first time interval; and
if the circuitry-level temperature does not remain substantially constant during the first time interval, determining whether the circuitry-level temperature remains substantially constant during a second time interval longer than the first time interval.

6. The method of claim 1, wherein operating the portable computing device during each of a plurality of time periods comprises sampling battery power during the time period to obtain a plurality of power samples, and determining an average of the power samples, the average of the power samples representing the unique amount of power defining the power value.

7. The method of claim 1, wherein determining an average skin temperature during each time period comprises sampling skin temperature during the time period to obtain a plurality of skin temperature samples, and determining an average of the plurality of skin temperature samples.

8. The method of claim 1, wherein:
monitoring a skin temperature comprises a computer monitoring a skin temperature sensor;
monitoring an ambient temperature comprises the computer monitoring an ambient temperature sensor;
determining an average skin temperature comprises the computer determining the average temperature;
determining an adjusted skin temperature comprises the computer determining the adjusted skin temperature; and
generating a plurality of pairs of data points comprises the computer generating the plurality of data points.

9. The method of claim 8, wherein determining an average skin temperature during each time period comprises the computer obtaining an indication of the time period from the portable computing device and correlating the indication of the time period with a skin temperature logging period.

10. The method of claim 1, wherein the portable computing device comprises at least one of a mobile telephone, a personal digital assistant, a pager, a smartphone, a navigation device, and a hand-held computer with a wireless connection or link.

11. A system for generating a Sustained Thermal Power Envelope in a portable computing device, the system comprising:
at least one skin temperature sensor;
at least one circuitry-level temperature sensor;
at least one ambient temperature sensor; and
one or more processors configured to:
monitor a circuitry-level temperature of the portable computing device using the at least one circuitry-level temperature sensor;
monitor a skin temperature of a housing of the portable computing device using the at least one skin temperature sensor;
monitor an ambient temperature in an environment external to the housing of the portable computing device using the at least one ambient temperature sensor;
operate the portable computing device during each of a plurality of time periods, during each time period the portable computing device drawing a unique amount of power defining a power value, during each time period the portable computing device maintaining the circuitry-level temperature at a substantially constant unique temperature;
determine an average skin temperature during each time period;
determine an adjusted skin temperature during each time period by subtracting the ambient temperature during the time period from the average skin temperature during the time period; and
generate a plurality of pairs of data points, each data point corresponding to one of the plurality of time periods, each data point comprising an adjusted skin temperature value and a power value.

12. The system of claim 11, wherein the one or more processors are further configured to determine a plurality of combinations, each combination corresponding to one of the time periods, each combination comprising at least one processor and corresponding operating frequency, each combination drawing the unique amount of power.

13. The system of claim 12, wherein the at least one processor includes large-core clusters and small-core clusters, and a small-core cluster and a large-core cluster are included in at least one of the combinations.

14. The system of claim 11, wherein the one or more processors are configured to operate the portable computing device during each of a plurality of time periods by being configured to detect when the circuitry-level temperature reaches the substantially constant unique temperature.

15. The system of claim 14, wherein the one or more processors are configured to detect when the circuitry-level temperature reaches the substantially constant unique temperature by being configured to:
determine whether the circuitry-level temperature remains substantially constant during a first time interval; and
determine whether the circuitry-level temperature remains substantially constant during a second time interval longer than the first time interval if the circuitry-level temperature does not remain substantially constant during the first time interval.

16. The system of claim 11, wherein the one or more processors are configured to operate the portable computing device during each of a plurality of time periods by being configured to sample battery power during the time period to obtain a plurality of power samples, and determine an average of the power samples, the average of the power samples representing the unique amount of power defining the power value.

17. The system of claim 11, wherein the one or more processors are configured to determine an average skin temperature during each time period by being configured to sample skin temperature during the time period to obtain a plurality of skin temperature samples, and determine an average of the plurality of skin temperature samples.

18. The system of claim 11, wherein the one or more processors include a computer processor external to the portable computing device and configured to:
determine the average temperature;
determine the adjusted skin temperature; and
generate the plurality of data points.

19. The system of claim 18, wherein the one or more processors are configured to determine an average skin temperature during each time period by the computer processor being configured to obtain an indication of the time period from the portable computing device and correlate the indication of the time period with a skin temperature logging period.

20. A system for generating a Sustained Thermal Power Envelope in a portable computing device, the system comprising:
means for monitoring a circuitry-level temperature of the portable computing device;
means for monitoring a skin temperature of a housing of the portable computing device;
means for monitoring an ambient temperature in an environment external to the housing of the portable computing device;
means for operating the portable computing device during each of a plurality of time periods, during each time period the portable computing device drawing a unique amount of power defining a power value, during each time period the portable computing device maintaining the circuitry-level temperature at a substantially constant unique temperature;
means for determining an average skin temperature during each time period; and
means for determining an adjusted skin temperature during each time period by subtracting the ambient temperature during the time period from the average skin temperature during the time period;
means for generating a plurality of pairs of data points, each data point corresponding to one of the plurality of time periods, each data point comprising an adjusted skin temperature value and a power value.

21. The system of claim 20, further comprising means for determining a plurality of combinations, each combination corresponding to one of the time periods, each combination comprising one or more processors and corresponding operating frequencies, each combination drawing the unique amount of power.

22. The system of claim 21, wherein the processors include large-core clusters and small-core clusters, and the means for determining a plurality of combinations includes a small-core cluster and a large-core cluster in at least one combination.

23. The system of claim 20, wherein the means for operating the portable computing device during each of a plurality of time periods comprises means for detecting when the circuitry-level temperature reaches the substantially constant unique temperature.

24. The system of claim 23, wherein the means for detecting when the circuitry-level temperature reaches the substantially constant unique temperature comprises:
means for determining whether the circuitry-level temperature remains substantially constant during a first time interval; and
means for determining whether the circuitry-level temperature remains substantially constant during a second time interval longer than the first time interval if the circuitry-level temperature does not remain substantially constant during the first time interval.

25. The system of claim 20, wherein the means for operating the portable computing device during each of a plurality of time periods comprises means for sampling battery power during the time period to obtain a plurality of power samples, and means for determining an average of the power samples, the average of the power samples representing the unique amount of power defining the power value.

26. The system of claim 20, wherein the means for determining an average skin temperature during each time period comprises means for sampling skin temperature during the time period to obtain a plurality of skin temperature samples, and means for determining an average of the plurality of skin temperature samples.

27. The system of claim 20, wherein:
the means for monitoring a skin temperature comprises logic in a computer external to the portable computing device configuring the computer to monitor a skin temperature sensor;
the means for monitoring an ambient temperature comprises logic in the computer configuring the computer to monitor the ambient temperature sensor;
the means for determining an average skin temperature comprises logic in the computer configuring the computer to determine the average temperature;
the means for determining an adjusted skin temperature comprises logic in the computer configuring the computer to determine the adjusted skin temperature; and
the means for generating a plurality of pairs of data points comprises logic in the computer configuring the computer to generate the plurality of data points.

28. The system of claim 27, wherein the means for determining an average skin temperature during each time period comprises means for obtaining an indication of the time period from the portable computing device and correlating the indication of the time period with a skin temperature logging period.

29. The system of claim 20, wherein the portable computing device comprises at least one of a mobile telephone, a personal digital assistant, a pager, a smartphone, a navigation device, and a hand-held computer with a wireless connection or link.

30. A computer program product comprising processor-executable logic embodied in at least one non-transitory storage medium, execution of the logic by one or more processors of a system including a portable computing device configuring the system to:
monitor a circuitry-level temperature of the portable computing device;
monitor a skin temperature of a housing of the portable computing device;
monitor an ambient temperature in an environment external to the housing of the portable computing device;
operate the portable computing device during each of a plurality of time periods, during each time period the portable computing device drawing a unique amount of power defining a power value, during each time period the portable computing device maintaining the circuitry-level temperature at a substantially constant unique temperature;
determine an average skin temperature during each time period;
determine an adjusted skin temperature during each time period by subtracting the ambient temperature during the time period from the average skin temperature during the time period; and
generate a plurality of pairs of data points, each data point corresponding to one of the plurality of time periods, each data point comprising an adjusted skin temperature value and a power value.
